(19) United States
(12) Patent Application Publication
(10) Pub. No.: US 2009/0317033 A1
(43) Pub. Date: Dec. 24, 2009

(54) INTEGRATED CIRCUIT AND PHOTONIC BOARD THEREOF

(75) Inventors: Chih-Tsung Shih, Hsinchu City (TW); Ding-Yuan Chen, Taichung City (TW); Hung-Pin Yang, Hsinchu City (TW); Shu-Mei Yang, Hsinchu County (TW); Shinh Chao, Hsinchu City (TW); Yung-Jui Chen, Ellicott City, MD (US); Chien-Jen Sun, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/142,808

(22) Filed: Jun. 20, 2008

(51) Int. Cl. G02B 6/12

(52) U.S. Cl. 385/14

(57) ABSTRACT

An integrated circuit (IC) including at least a first and a second logical blocks and a photonic board is provided. The photonic board connects with the first and the second logical blocks through a eutectic bonding technology, and communicates at least a logical signal of the first logical block to the second logical block by light conduction.

### BACKGROUND OF THE INVENTION

1. Field of the Invention

The present invention relates to an integrated circuit, and more particularly, to an integrated circuit having enhanced performance.

2. Description of the Related Art

In order to increase functions and performance of a conventional integrated circuit (IC), the concept of system on chip (SOC) or multi-chip has been embedded in the conventional IC. However, since the mediums for communicating logical signals between two logical blocks within the IC applied the concept of SOC or multi-chip still adopt metal wires, such as aluminum or copper wires, when the IC embedded with the SOC or multi-chip operates in an extremely high frequency and a distance between the two logical blocks is increased, an RC delay time caused by the metal wires can restrain the transmission rate between the two logical blocks. Accordingly, the performance of the IC embodying the concept of SOC or multi-chip is also limited.

### SUMMARY OF THE INVENTION

The present invention adopts light conduction to replace metal conduction for communicating between any two logical blocks within an integrated circuit (IC), so as to enhance the performance of the IC.

The present invention provides a photonic board including a substrate, a passivation layer and a eutectic bonding layer. The substrate includes a plurality of optical devices which are used for communicating logic signals between a plurality of logical blocks within an integrated circuit (IC) by light conduction. The passivation layer is disposed over the substrate for protecting and isolating the optical devices. The eutectic bonding layer is disposed over the passivation layer for connecting a part of the optical devices with the logical blocks through a eutectic bonding technology.

The present invention further provides an IC including at least a first and a second logical blocks and a photonic board. The photonic board connects with the first and the second logical blocks through a eutectic bonding technology. Both of the first logical block and the second logical block communicate with each other by light conduction through the photonic board.

The present invention adopts light conduction to replace metal conduction for communicating between any two logical blocks within the IC, so that even if a distance between the two logical blocks is increased, the transmission rate between the two logical blocks is not restrained, and thus the performance of the IC of the present invention is substantially enhanced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an integrated circuit (IC) according to an embodiment of the present invention.

FIG. 2 is a diagram of a photonic board according to an embodiment of the present invention.

FIG. 3 is a diagram of a part of a substrate of a photonic board according to an embodiment of the present invention.

FIG. 4 is a diagram of a photonic board according to another embodiment of the present invention.

FIG. 5 is a diagram of a part of a substrate and an atomic bonding layer of a photonic board according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention is directed to an IC having enhanced performance. Below, the characteristics and advantages of the technique in the present invention will be described in detail.

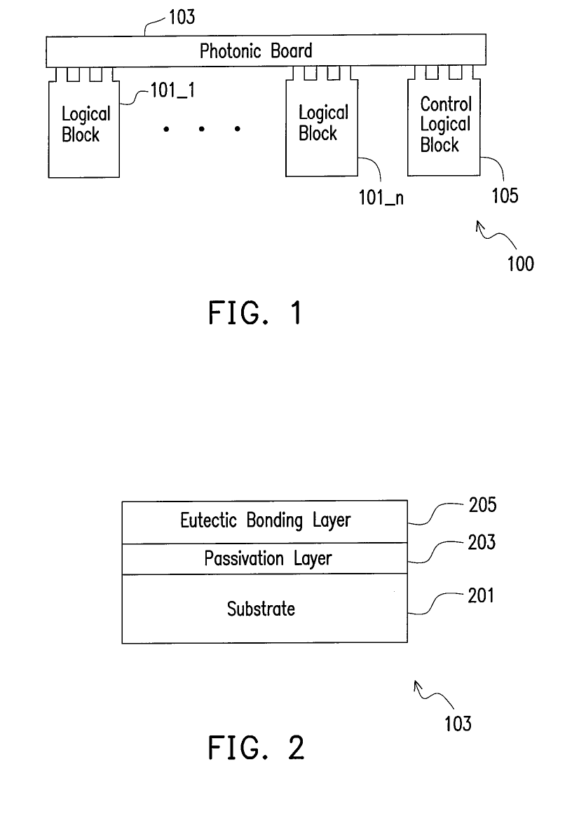

FIG. 1 is a diagram of an integrated circuit (IC) 100 according to an embodiment of the present invention. Referring to FIG. 1, the IC includes a plurality of logical blocks 101_1˜101_{—}n, a photonic board 103 and a control logical blocks 105. In the present embodiment, each logical block 101_1˜101_{—}n is consisted of many logical gates which are not shown in FIG. 1, and the functions of each of the logical blocks 101_1˜101_{—}n may be at least one of NOT gate, AND gate, OR gate, register etc., though the present invention is not limited thereto. The photonic board 103 connects with all of the logical blocks 101_1˜101_{—}n and the control logical block 105 through a eutectic bonding technology, and communicates, for example, at least a logical signal of the logical block 101_1 to, for example, the logical block 101_{—}n.

FIG. 2 is a diagram of the photonic board 103 according to an embodiment of the present invention. Referring to FIG. 1 and FIG. 2 both, the photonic board 103 includes a substrate 201, a passivation layer 203 and a eutectic bonding layer 205. The substrate 201 includes a plurality of optical devices which are not shown in FIG. 2. The optical devices of the substrate 201 are used for communicating logical signals between the logical blocks 101_1˜101_{—}n (for example, at least a logical signal of the logical block 101_1 to the logical block 101_{—}n) by light conduction. In the present embodiment, the material of the substrate 201 may be silicon, though the present invention is not limited thereto. The passivation layer 203 is disposed over the substrate 201 and used for protecting and isolating the optical devices of the substrate 201. The eutectic bonding layer 205 is disposed over the passivation layer 203 and connected with all of the logical blocks 101_1˜101_{—}n and the control logical block 105 through a eutectic bonding technology.

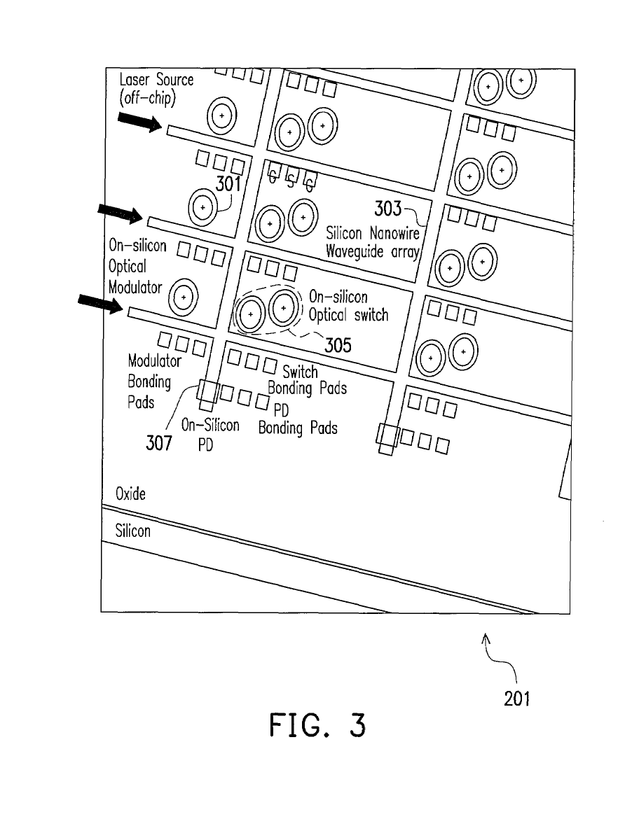

FIG. 3 is a diagram of a part of the substrate 201 of the photonic board 103 according to an embodiment of the present invention. Referring to FIG. 1 through FIG. 3, the optical devices of the substrate 201 include a plurality of optical modulators 301, such as ring type modulators but not limited thereto, a waveguide array 303, a plurality of optical switches 305, such as ring type switches but not limited thereto, and a plurality of photo detectors (PD) 307. In the present embodiment, the optical modulators 301 may receive logical signals of the logical blocks 101_1˜101_{—}n through a plurality of modulator bonding pads and convert the received logical signals to optical signals.

The waveguide array 303 is used for receiving an external laser source (i.e., an off-chip laser source) so as to conduct the optical signals converted by the optical modulators 301. Each optical switch 305 is placed at an intersection of the waveguide array 303, and controlled by the control logical block 105 through a plurality of switch bonding pads for determining conduction direction of the optical signals converted by the optical modulators 301 in the waveguide array 303. The photo detectors 307 are used for converting the optical signals converted by the optical modulators 301 back to the logical signals of the logical blocks 101_1˜101_{—}n, and communicating the logical signals converted by the photo detectors 307 to the logical blocks 101_1˜101_{—}n through a plurality of PD bonding pads.

From the above, all of the logical blocks 101_1˜101_{—}n within the IC 100 adopt light conduction for communicating logical signals from each other, so that even if a distance between any two logical blocks 101_1˜101_{—}n is increased, the transmission rate between the (any) two logical blocks is not restrained, and thus the performance of the IC 100 of the present invention is substantially enhanced.

However, the scope of the present invention is not limited to the above embodiment. Further, other photonic boards of other embodiments in the present invention will be described in detail below.

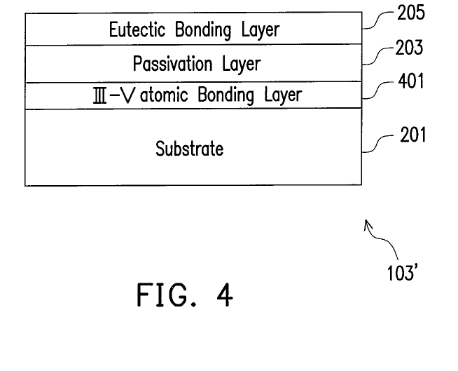

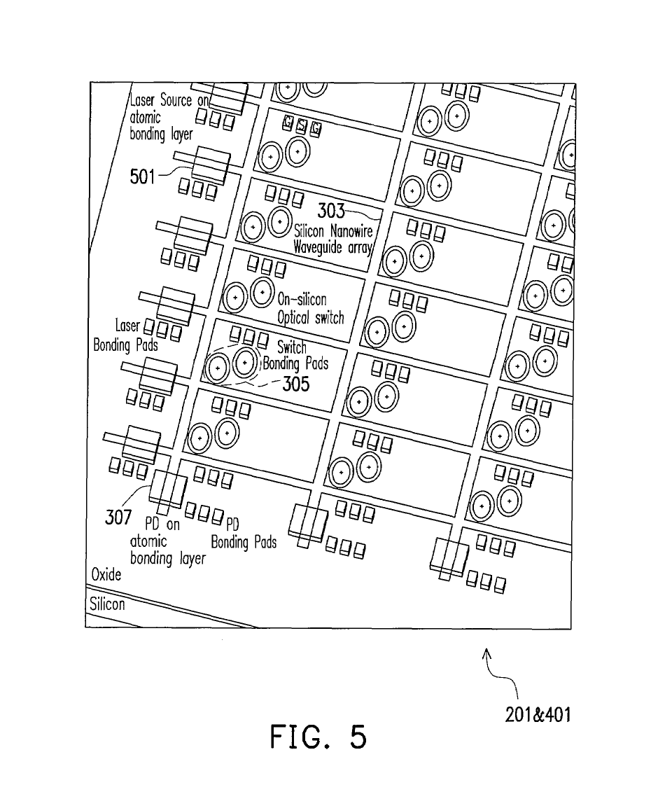

FIG. 4 is a diagram of a photonic board 103′ according to another embodiment of the present invention. Referring to FIG. 1, FIG. 2 and FIG. 4 altogether, the difference between the photonic board 103′ and 103 is a III-V atomic bonding layer 401 disposed between the substrate 201 and the passivation layer 203. Accordingly, FIG. 5 is a diagram of a part of the substrate 201 and the atomic bonding layer 401 of the photonic board 103′ according to an embodiment of the present invention. Referring to FIG. 1 through FIG. 5, the atomic bonding layer 401 includes a plurality of laser sources 501 in itself, and the laser sources 501 of the atomic bonding layer 401 receive logical signals of the logical blocks 101_1˜101_{—}n through a plurality of laser bonding pads for converting the received logical signals to optical signals. Accordingly, the optical modulators 301 manufactured on the substrate 201 may be omitted in this embodiment.

In addition, the photo detectors 307 originally manufactured on the substrate 201 may also be manufactured on the atomic bonding layer 401, so that the photo detectors 307 originally manufactured on the substrate 201 may be omitted in this embodiment. On the other hand, in the other embodiments of the present invention, only the photo detectors 307 originally manufactured on the substrate 201 may be transferred to the atomic bonding layer 401, and the optical modulators 301 originally manufactured on the substrate 201 may be retained, which means the atomic bonding layer 401 does not have the laser sources 501 therein, or that only the laser sources 501 are manufactured on the atomic bonding layer 401, and the photo detectors 307 originally manufactured on the substrate 201 are retained. The above-mentioned embodiments all fall into the scope of the present invention.

In summary, the present invention mainly adopts light conduction to replace metal conduction for communicating between any two logical blocks within the conventional IC, so that even if a distance between the two logical blocks is increased, the transmission rate between the two logical blocks is not restrained, and thus the performance of the IC of the present invention is substantially enhanced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A photonic board, comprising:
a substrate, comprising a plurality of optical devices, wherein the optical devices are used for communicating at least a logical signal of a first logical block within a single integrated circuit (IC) to a second logical block within the single IC by light conduction;
a passivation layer, disposed over the substrate, for protecting and isolating the light devices; and
a eutectic bonding layer, disposed over the passivation layer, for connecting a part of the optical devices with the first and the second logical blocks through a eutectic bonding technology,
wherein the photonic board is embedded within the single IC.

2. The photonic board according to claim 1, wherein the optical devices at least comprise:
an optical modulator, for receiving the logical signal through a plurality of first bonding pads and converting the received logical signal to an optical signal;
a waveguide array, for receiving an external laser source so as to conduct the optical signal;
a plurality of optical switches, respectively placed at intersections of the waveguide array, wherein each optical switch is controlled by a control logical block within the single IC through a plurality of second bonding pads for determining a conduction direction of the optical signal in the waveguide array; and
a photo detector, for converting the optical signal back to the logical signal, and conducting the converted logical signal to the second logical block through a plurality of third bonding pads.

3. The photonic board according to claim 1, further comprising:
an atomic bonding layer, disposed between the substrate and the passivation layer, the atomic bonding layer comprising a laser source for receiving the logical signal through a plurality of first bonding pads and converting the received logical signal to an optical signal.

4. The photonic board according to claim 3, wherein the optical devices at least comprise:
a waveguide array, for receiving the laser source so as to conduct the optical signal;
a plurality of optical switches, respectively placed at intersections of the waveguide array, wherein each optical switch is controlled by a control logical block within the single IC through a plurality of second bonding pads for determining a conduction direction of the optical signal in the waveguide array; and
a photo detector, for converting the optical signal back to the logical signal, and conducting the converted logical signal to the second logical block through a plurality of third bonding pads.

5. The photonic board according to claim 3, wherein the optical devices at least comprise:
a waveguide array, for receiving the laser source so as to conduct the optical signal; and
a plurality of optical switches, respectively placed at intersections of the waveguide array, wherein each optical switch is controlled by a control logical block within the single IC through a plurality of second bonding pads for determining a conduction direction of the optical signal in the waveguide array.

6. The photonic board according to claim 5, wherein the atomic bonding layer further comprises a photo detector for converting the optical signal back to the logical signal, and conducting the converted logical signal to the second logical block through a plurality of third bonding pads.

7. The photonic board according to claim 1, wherein the optical devices at least comprise:
an optical modulator, for receiving the logical signal through a plurality of first bonding pads and converting the received logical signal to an optical signal;
a waveguide array, for receiving an external laser source so as to conduct the optical signal; and
a plurality of optical switches, respectively placed at intersections of the waveguide array, wherein each optical switch is controlled by a control logical block within the single IC through a plurality of second bonding pads for determining a conduction direction of the optical signal in the waveguide array.

8. The photonic board according to claim 7, further comprising:
an atomic bonding layer, disposed between the substrate and the passivation layer, the atomic bonding layer comprising a photo detector for converting the optical signal back to the logical signal, and conducting the converted logical signal to the second logical block through a plurality of third bonding pads.

9. A single integrated circuit (IC), comprising:
at least a first and a second logical blocks; and
a photonic board, for connecting with the first and the second logical blocks through a eutectic bonding technology, and communicating at least a logical signal of the first logical block to the second logical block by light conduction,
wherein both the first and the second logical blocks communicate with each other by light conduction through the photonic board, and the photonic board is embedded within the single IC.

10. The single IC according to claim 9, wherein the photonic board comprises:
a substrate, comprising a plurality of optical devices, wherein the optical devices are used for communicating the logical signal to the second logical block by light conduction;
a passivation layer, disposed over the substrate, for protecting and isolating the light devices; and
a eutectic bonding layer, disposed over the passivation layer, for connecting a part of the optical devices with the first and the second logical blocks through the eutectic bonding technology.

11. The single IC according to claim 10, further comprising a control logical block, wherein the eutectic bonding layer further connects the part of the optical devices with the first and the second logical blocks through the eutectic bonding technology.

12. The single IC according to claim 11, wherein the optical devices at least comprise:
an optical modulator, for receiving the logical signal through a plurality of first bonding pads and converting the received logical signal to an optical signal;
a waveguide array, for receiving an external laser source so as to conduct the optical signal;
a plurality of optical switches, respectively placed at intersections of the waveguide array, wherein each optical switch is controlled by a control logical block within the single IC through a plurality of second bonding pads for determining a conduction direction of the optical signal in the waveguide array; and
a photo detector, for converting the optical signal back to the logical signal, and conducting the converted logical signal to the second logical block through a plurality of third bonding pads.

13. The single IC according to claim 11, wherein the photonic board further comprises:
an atomic bonding layer, disposed between the substrate and the passivation layer, the atomic bonding layer comprising a laser source for receiving the logical signal through a plurality of first bonding pads and converting the received logical signal to an optical signal.

14. The single IC according to claim 13, wherein the optical devices at least comprise:
a waveguide array, for receiving the laser source so as to conduct the optical signal;
a plurality of optical switches, respectively placed at intersections of the waveguide array, wherein each optical switch is controlled by a control logical block within the single IC through a plurality of second bonding pads for determining a conduction direction of the optical signal in the waveguide array; and
a photo detector, for converting the optical signal back to the logical signal, and conducting the converted logical signal to the second logical block through a plurality of third bonding pads.

15. The single IC according to claim 13, wherein the optical devices at least comprise:
a waveguide array, for receiving the laser source so as to conduct the optical signal; and
a plurality of optical switches, respectively placed at intersections of the waveguide array, wherein each optical switch is controlled by a control logical block within the single IC through a plurality of second bonding pads for determining a conduction direction of the optical signal in the waveguide array.

16. The single IC according to claim 15, wherein the atomic bonding layer further comprises a photo detector for converting the optical signal back to the logical signal, and conducting the converted logical signal to the second logical block through a plurality of third bonding pads.

17. The single IC according to claim 11, wherein the optical devices at least comprise:
an optical modulator, for receiving the logical signal through a plurality of first bonding pads and converting the received logical signal to an optical signal;
a waveguide array, for receiving an external laser source so as to conduct the optical signal; and
a plurality of optical switches, respectively placed at intersections of the waveguide array, wherein each optical switch is controlled by a control logical block within the single IC through a plurality of second bonding pads for determining a conduction direction of the optical signal in the waveguide array.

18. The single IC according to claim 17, further comprising:
an atomic bonding layer, disposed between the substrate and the passivation layer, the atomic bonding layer comprising a photo detector for converting the optical signal back to the logical signal, and conducting the converted logical signal to the second logical block through a plurality of third bonding pads.

19. (canceled)
